(19) United States
(12) Patent Application Publication
(10) Pub. No.: US 2013/0245516 A1
(43) Pub. Date: Sep. 19, 2013

(54) SELF-APPLICATOR FOR AN AIRWAY CLEARANCE DEVICE

(71) Applicant: Susan B. Davis, San Diego, CA (US)

(72) Inventor: Susan B. Davis, San Diego, CA (US)

(21) Appl. No.: 13/422,402

(22) Filed: Mar. 16, 2012

(51) Int. Cl. A61H 23/00

(52) U.S. Cl. 601/107

(57) ABSTRACT

A self-applicator for a percussor or airway clearance device has first and second straps that overlay one another and define an open area in-between. A pouch for holding the percussor is secured in the open area. Handles on the ends of the straps permit a user to easily hold the self-applicator against his/her back while using the percussor. One of the handles has an adjustable length harness to accommodate users of different sizes. An application surface on one of the straps is configured to make contact with the user's back and permit the percussor to contact the user's back through the strap.

### FIELD OF INVENTION

The present invention is directed to a self-applicator for an airway clearance device. Specifically, the present invention is directed to a strap system that holds an airway clearance device, i.e., percussor, in a secure manner such that an individual can apply the percussor to their back without assistance from another person.

### BACKGROUND OF THE INVENTION

A percussor is a medical device for supplying impulse forces to a patient's back or chest for the purpose of loosening and dislodging bronchial secretions in the lungs. The present invention is of a system of straps to allow a person to properly apply a percussor against his or her own back.

Although there are many types of percussors, the present invention is preferably used with a percussor based on the use of a solenoid in developing inpulse forces for application to a patient's back. A solenoid is “a coil that surrounds a movable iron core which is pulled to a central position with respect to the coil when the coil is energized by sending current through it.”

By the nature of such a percussor and human physiology, it is extremely difficult for individual to self-apply a percussor to their own back. The present invention makes it possible for an individual to hold a percussor against his or her own back so as to properly apply the impacting force for the purpose of loosening and dislodging bronchial secretions in the lungs. The person can self-apply the percussor so as to not require the services of a technician in using the percussor.

Accordingly, there is a need for a self-applicator for an airway clearance device that addresses these needs. The present invention fulfills these needs and provides other related advantages.

### SUMMARY OF THE INVENTION

A self-applicator for an airway clearance device comprises first and second straps joined at their respective ends. The first strap overlays and is substantially co-extensive with the second strap. A pouch for holding the airway clearance device is disposed between the first and second straps. The self-applicator also comprises a pair of handles with one each attached to one of the respective ends of the first and second straps.

The first strap is preferably longer than the second strap so as to define an open region between the two straps. The second strap has an application surface on one side. The application surface comprises a padded material and is configured so as to make physical contact with a user's back. The pouch is disposed in the open region. The pouch is attached to at least one and preferably both of the straps.

The pouch comprises a closure mechanism. The closure mechanism is configured so as to securely hold the airway clearance device. The closure mechanism comprises adjustable hook and loop straps configured so as to accommodate airway clearance devices of varying sizes.

At least one of the pair of handles is attached to one of the ends of the first and second straps by an adjustable length harness. The other of the pair of handles is attached to the other of the ends of the first and second straps by a fixed length harness.

A method for using the self-applicator begins with the step of inserting the airway clearance device into the pouch. The airway clearance device is positioned in the pouch such that an anvil on the device is oriented toward the second strap. A user then grasps each of the pair of handles in his/her hands. The user then self-applies the application surface of the second strap to his/her back. The airway clearance device is turned on such that a force delivering surface of the anvil contacts the user's back through the application surface.

The method further comprises the step of closing the closure mechanism on the pouch so as to securely hold the airway clearance device in the pouch. The method also comprises the step of adjusting the length of the adjustable length harness on one of the pair of handles so that the user can comfortably perform the self-applying step.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is an elevated perspective view of the self-applicator of the present invention;

FIG. 2 is an elevated perspective view of the self-applicator of the present invention illustrating insertion of a percussor;

FIG. 3 is an exploded perspective view of the self-applicator of the present invention;

FIG. 4 is an environmental view of the self-applicator of the present invention being self-applied by a user; and

FIG. 5 is a close-up cut-away view of the self-applicator of the present invention being self-applied by a user.

### DETAILED DESCRIPTION OF THE PREFERRED EMBODIMENT

The present invention is directed to a self-applicator for an airway clearance device, the self-applicator being referred to generally by reference numeral 10. The self-applicator 10 is configured to accept and securely retain an airway clearance device or percussor 12. An airway clearance device or percussor 12 of the type contemplated to be used with the present invention is described in U.S. Patent Application Publication No. US2010/0113993, the disclosure of which is hereby incorporated herein by this reference.

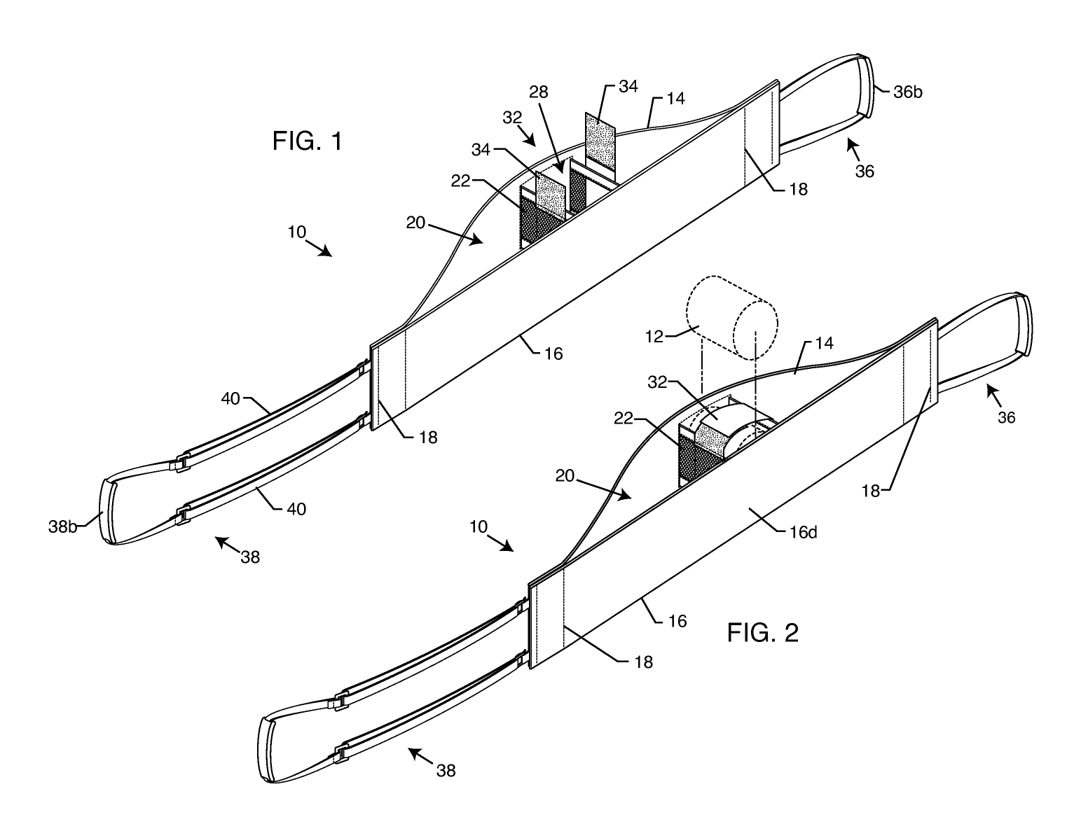

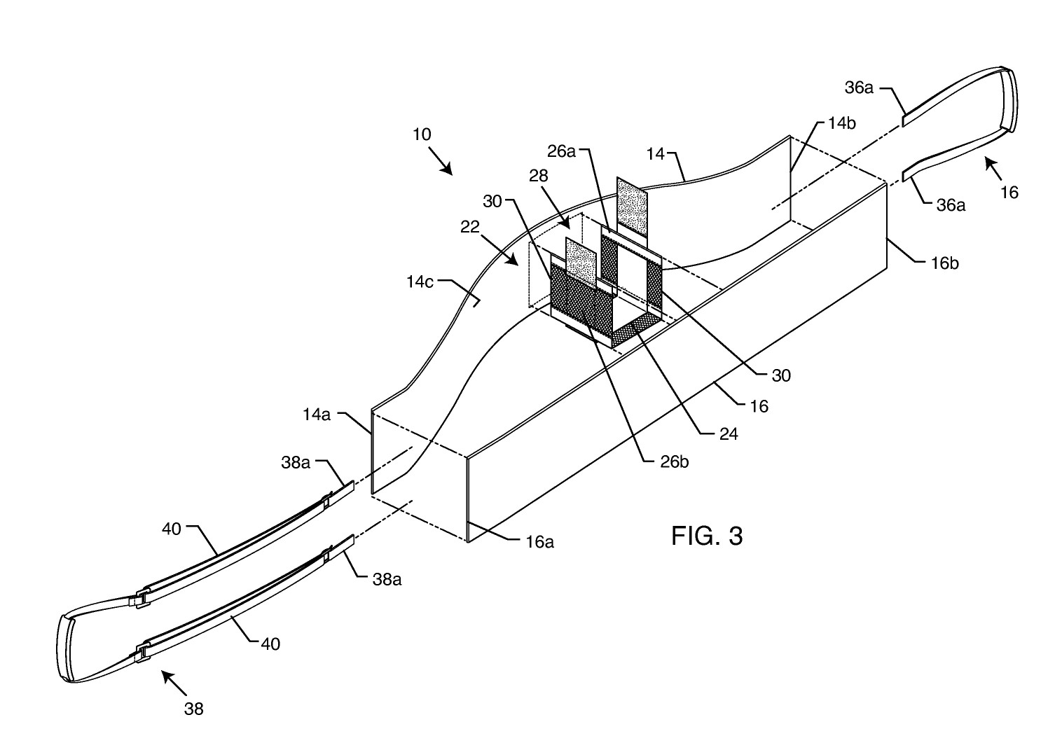

FIGS. 1 through 3 illustrate the self-applicator 10 along with its various components. The self-applicator 10 has a pair of straps 14, 16 being substantially co-extensive with one overlaying the other. The respective ends of the straps 14a, 16a and 14b, 16b are stitched 18 together or joined by any securing means know to those skilled in the art. One of the straps 14 is preferably slightly longer that the second strap 16 such that when the ends of the first strap 14a, 14b are joined to the ends of the second strap 16a, 16b, there is an open area 20 between the two straps 14, 16. Preferably, the stitching 18 or other securing means is applied a second time 18a for added securement.

A pouch 22 is disposed in the open area 20 between the straps 14,16. The pouch 22 may be in the form of a U-shaped pocket having a bottom 24, upright sides 26a, 26b and an open top 28. The pouch 32 in configured and designed to accept the percussor 12 through the open top 28 and securely retain the percussor 12 therein. Front and back edges 30a, 30b are in contact with inside surfaces 14c, 16c of the strap 14, 16. At least one of the front and back edges 30a, 30b are attached to the inside surfaces 14c, 16c so as to securely retain the pouch 22 in the open area 20. Preferably, both front and back edges 30a, 30b are attached to the inside surfaces 14c, 16c.

The pouch 22 also includes a closure mechanism 32 designed to cover the open top 28. The closure mechanism 32 preferably comprises a pair of adjustable hook and loop straps 34a, 34b. The straps 34a, 34b preferably have essential their entire mating surfaces covered by hook and loop material, i.e., VELCRO®, whereby the respective straps 34a, 34b can be adhered to each other at any point along their length. The closure mechanism 32 can also comprise snaps, buttons, a zipper, or other commonly known methods of closure.

A pair of handles 36, 38 are secured to the respective ends 14a/16a, 14b/16b of the straps. The ends 36a, 38a of the handles 36, 38 are preferably secured between the ends 14a/16a, 14b/16b of the straps when they are stitched 18 together. At least one of the straps 38 includes an adjustable length harness 40 so that the length of the handle 38 may be changed to accommodate users of different sizes. Each of the handles 36, 38 include respective grips 36b, 38b for a user 40 to grasp in each of his/her hands 44.

The second strap 16 includes an applicator surface 16d that is configured to contact the back 46 of a user 42 when the self-applicator 10 being applied. The application surface 16d is aligned with the inside surface 16c at the point where the pouch 22 is disposed or secured. The applicator surface 16d preferably comprises a soft, comfortable material that will not irritate a user's skin and can easily and smoothly move during use. The applicator surface 16d may even include padding to provide comfort to the user.

The method of using the self-applicator 10 begins with arranging the self-applicator 10 on a surface such that the pouch 22 is oriented with the open top 28 pointing upwards. A user then inserts the percussor 12 into the open top 28 of the pouch. The percussor 12 is positioned in the pouch such that an anvil 12a on the percussor 12 is pointed toward the inside surface 16c of the second strap 16. The closure mechanism 32 is secured around the percussor 12 so as to securely retain the percussor 12 in the pouch 22 in a manner that does not allow rotation, revolution or other similar movements during use.

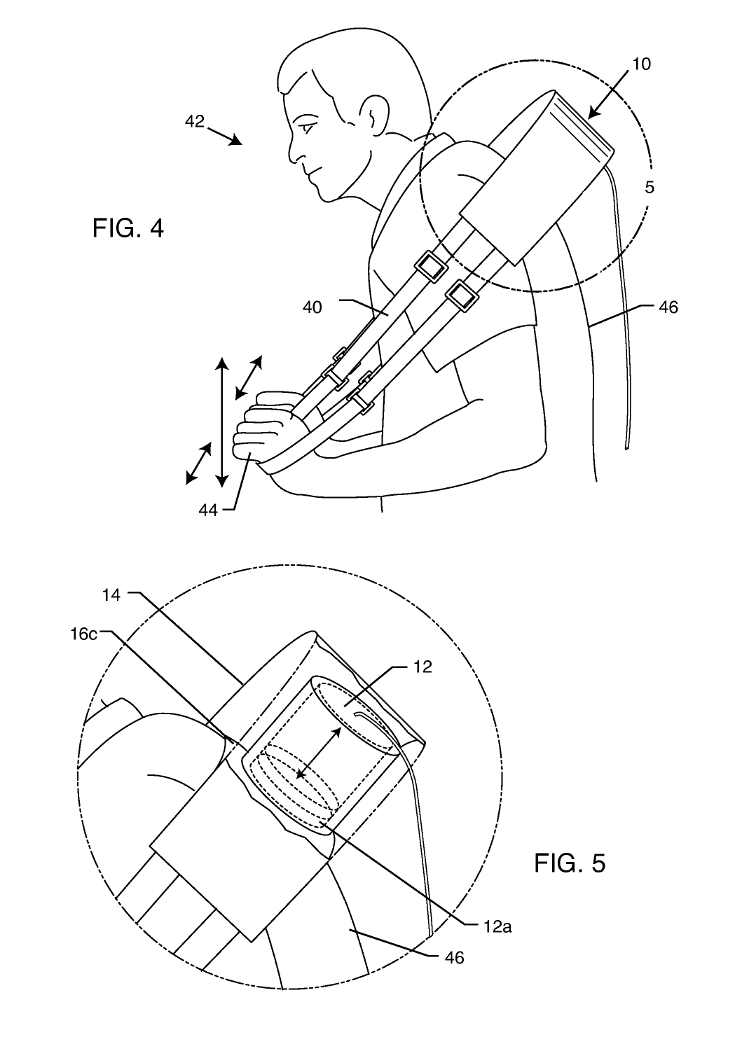

If necessary, the user 42 can adjust the length of the adjustable length harness 40 to make the self-applicator 10 more comfortable to use. The user 42 then grasps each of the handles 38, 36 in his or her hands 44 and self-applies the application surface 16d to his/her back 46. As illustrated in FIGS. 4 and 5, the self-applicator 10 spans the user's back 46 with the user's hand 44 in front of his/her body, pulling the handles 36, 38 forward to apply pressure to the back 46. The user 42 then turns on the percussor 12.

By moving ones hand 44 up/down and side/side, the user 42 can self-apply the percussor 12 to almost any area of his/her back 46. By aligning the anvil 12a of the percussor 12 with the application surface 16d, the user is able to keep the anvil 12a in contact with the user's back 46 without the need for a treatment technician or the aid of any other person. The user can also more easily self-apply the percussor 12 to those parts of his/her back 46 that are most beneficial for the loosening or dislodging of bronchial secretions in the lungs, rather than try and describe to another person where to apply the percussor 12.

Except for the applicator surface 16d, described above, the self-applicator 10 and its various components are made from a sturdy, durable material such as nylon or similar polymer material. The goal in selecting a material is to make sure that the self-applicator 10 is comfortable for the user while durable enough to withstand the stresses of self-application and the movement of the percussor 12. The grips 36b, 38b preferably comprise a soft, durable polymer material such as polyurethane, latex, or similar materials, molded to form hand grips 36b, 38b.

Although the self-applicator 10 has been described in detail for purposes of illustration, various modifications may be made without departing from the scope and spirit of the invention. The above-described disclosure is not intended to limit the scope of the invention. Accordingly, the scope of the present invention is determined only by the following claims.

What is claimed is:

1. A self-applicator for an airway clearance device, comprising:
a first strap overlaying and being substantially co-extensive with a second strap, wherein the first and second straps are joined at their respective ends;
a pouch for holding the airway clearance device disposed between the first and second straps; and
a pair of handles, one each attached to one of the respective ends of the first and second straps.

2. The self-applicator of claim 1, wherein the first strap is longer than the second strap so as to define an open region therebetween.

3. The self-applicator of claim 2, wherein the second strap has an application surface comprising a padded material configured so as to make physical contact with a user's back.

4. The self-applicator of claim 2, wherein the pouch is disposed in the open region and attached to one of the straps.

5. The self-applicator of claim 4, wherein the pouch is attached to both the first and second straps.

6. The self-applicator of claim 1, wherein the pouch comprises a closure mechanism and is configured so as to securely hold the airway clearance device.

7. The self-applicator of claim 6, wherein the closure mechanism comprises adjustable hook and loop straps configured so as to accommodate airway clearance devices of varying sizes.

8. The self-applicator of claim 1, wherein one of the pair of handles is attached to one of the ends of the first and second straps by an adjustable length harness.

9. The self-applicator of claim 8, wherein the other of the pair of handles is attached to the other of the ends of the first and second straps by a fixed length harness.

10. The method for using the self-applicator of claim 1, comprising the steps of:
inserting the airway clearance device into the pouch;
positioning the airway clearance device in the pouch such that an anvil on the airway clearance device is oriented toward the second strap;
grasping each of the pair handles in a user's hands;
self-applying an application surface of the second strap to the user's back; and
turning on the airway clearance device such that a force delivering surface of the anvil contacts the user's back through the application surface.

11. The method of claim 10, further comprising the step of closing a closure mechanism on the pouch so as to securely hold the airway clearance device in the pouch.

12. The method of claim 10, further comprising the step of adjusting the length of an adjustable length harness on one of the pair of handles so that the user can comfortably perform the self-applying step.

13. A self-applicator for an airway clearance device, comprising:
a first strap overlaying and being substantially co-extensive with a second strap, wherein the first strap is longer than the second strap so as to define an open region therebetween and the first and second straps are joined at their respective ends;
a pouch for holding the airway clearance device disposed in the open region between the first and second straps and attached to one of the first and second straps; and
a pair of handles, one each attached to one of the respective ends of the first and second straps.

14. The self-applicator of claim 13, wherein the second strap has an application surface comprising a padded material configured so as to make physical contact with a user's back.

15. The self-applicator of claim 13, wherein the pouch is attached to both the first and second straps.

16. The self-applicator of claim 13, wherein the pouch comprises a closure mechanism and is configured so as to securely hold the airway clearance device.

17. The self-applicator of claim 16, wherein the closure mechanism comprises adjustable hook and loop straps configured so as to accommodate airway clearance devices of varying sizes.

18. The self-applicator of claim 13, wherein one of the pair of handles is attached to one of the ends of the first and second straps by an adjustable length harness.

19. The self-applicator of claim 18, wherein the other of the pair of handles is attached to the other of the ends of the first and second straps by a fixed length harness.

20. The method for using the self-applicator of claim 13, comprising the steps of:
inserting the airway clearance device into the pouch;
positioning the airway clearance device in the pouch such that an anvil on the airway clearance device is oriented toward the second strap;
closing a closure mechanism on the pouch so as to securely hold the airway clearance device in the pouch;
adjusting the length of an adjustable length harness on one of the pair of handles;
grasping each of the pair handles in a user's hands;
self-applying an application surface of the second strap to the user's back; and
turning on the airway clearance device such that a force delivering surface of the anvil contacts the user's back through the application surface.
